(19) United States
(12) Patent Application Publication
(10) Pub. No.: US 2025/0087730 A1
(43) Pub. Date: Mar. 13, 2025

(54) FLOW BATTERY CELL

(71) Applicant: SHARP KABUSHIKI KAISHA, Sakai City (JP)

(72) Inventors: TOMO KITAGAWA, Sakai City (JP); Hirotaka Mizuhata, Sakai City (JP); Shinobu Takenaka, Sakai City (JP); Akihito Yoshida, Sakai City (JP)

(21) Appl. No.: 18/882,655

(22) Filed: Sep. 11, 2024

(30) Foreign Application Priority Data
Sep. 13, 2023 (JP) 2023-148000

(51) Int. Cl. H01M 8/04186; H01M 8/18

(52) U.S. Cl. CPC H01M 8/04186; H01M 8/188

(57) ABSTRACT

A flow battery cell comprises a slurry containing solid active materials and an electrolytic solution; a negative-electrode chamber for supplying the slurry; a positive-electrode chamber for supplying air; and a solution-feed controlling unit configured to change a rate of supply of the slurry.

### CROSS-REFERENCE TO RELATED APPLICATION

The present application claims priority from Japanese Application JP2023-148000, the content of which is hereby incorporated by reference into this application.

### BACKGROUND

### 1. Field

The present disclosure relates to a flow battery cell.

### Description of Embodiments

Battery cells have been disclosed since before.

For instance, Metal-Air Batteries: Present and Perspectives discloses a battery using zinc slurry dispersed uniformly by a binder.

### SUMMARY

However, in the battery disclosed in Metal-Air Batteries: Present and Perspectives, increasing the weight ratio of zinc, which is an active material, provides high viscosity, thus increasing pump energy consumption due to a pressure loss.

In view of the above problem, it is an object of the present disclosure to provide a flow battery cell with less pump energy consumption without degrading battery performance.

A flow battery cell according to the present disclosure is provided with the following: a slurry containing solid active materials and an electrolytic solution; a negative-electrode chamber for supplying the slurry; a positive-electrode chamber for supplying air; and a solution-feed controlling unit configured to change a rate of supply of the slurry.

As described above, the present disclosure can provide a flow battery cell with less pump energy consumption without degrading battery performance.

### BRIEF DESCRIPTION OF THE DRAWINGS

FIG. 1 is a schematic cross-sectional view of a flow battery cell according to the present disclosure;

FIG. 2 is a graph showing thickener concentration and solution viscosity (electrolytic solution); and

FIG. 3 is a schematic cross-sectional view of a modification of the flow battery cell illustrated in FIG. 1.

### DESCRIPTION OF EMBODIMENTS

A preferred embodiment of the present disclosure will be detailed with reference to the drawings. It is noted that this embodiment described below does not unduly limit the contents of the present disclosure recited in the claims, and not all the configurations described in this embodiment are necessarily essential as the means for solution in the present disclosure. It is also noted that the drawings show X-, Y-, and Z-axes, among which the Z-axis, in particular, indicates the direction of gravity (height direction) of a flow battery cell.

The flow battery cell, 100, according to the present disclosure is a flow metal-air battery for instance. The battery of the flow battery cell 100 takes in air and generates electric power in a power generating unit (not shown) by using the air. The battery is then charged in a charging unit (not shown) and discharges air.

Further, the flow battery cell 100 falls under a flow type, which is a battery that allows slurry to circulated in its negative-electrode chamber, which will be described later on. The configuration of the flow battery cell will be described below.

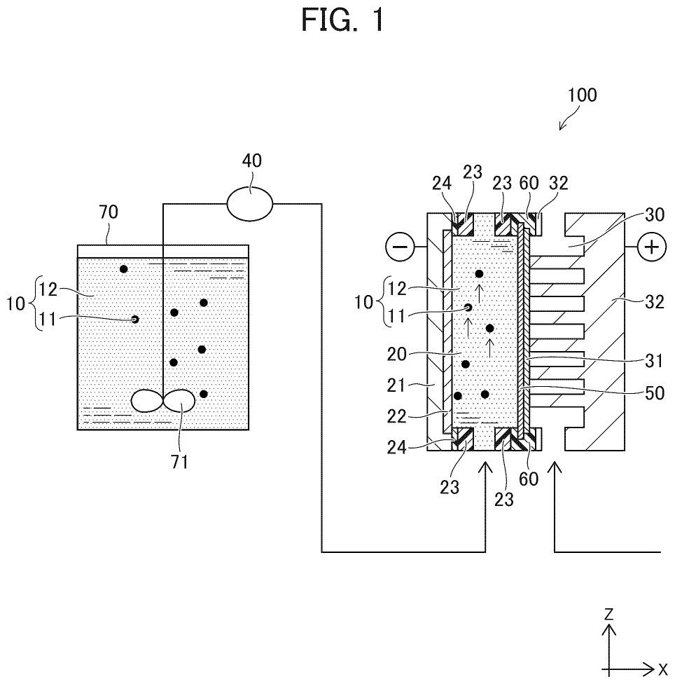

FIG. 1 is a schematic cross-sectional view of the flow battery cell 100 according to the present disclosure. As illustrated in FIG. 1, the flow battery cell 100 according to the present disclosure is provided with a slurry 10, a negative-electrode chamber 20, an negative-electrode energization plate 21, a negative electrode 22, a negative-electrode flow-path layer 23, a gasket 24, a positive-electrode chamber 30, a positive electrode 31, a positive-electrode energization plate 32, a separator 50, a seal portion 60, and a solution-feed controlling unit 40. The flow battery cell 100 according to the present disclosure is produced by overlaying these components together.

The negative-electrode chamber 20 is supplied with the slurry 10, which will be described later on. The negative-electrode chamber 20 is a space partitioned by the separator 50, the negative-electrode flow-path layers 23, and the negative electrode 22. Further, the negative electrode 22 can have various shapes depending on the negative electrode 22 and negative-electrode flow-path layers 23.

The negative-electrode energization plate 21 is made of a conductive material that passes current between the negative electrode 22 and negative-electrode energization plate 21. The negative-electrode energization plate 21 may have any shape.

The negative electrode 22 is made of a material having conductivity and corrosion resistance to the slurry 10. As illustrated in FIG. 1, the negative electrode 22 and the negative-electrode energization plate 21 may be composed of separate members, or the negative electrode 22 may serve also as the negative-electrode energization plate 21.

The negative-electrode flow-path layer 23 may be sandwiched by the separator 50 and the negative electrode 22 and/or negative-electrode energization plate 21. Further, the negative electrode 22 may serve also as the negative-electrode flow-path layer 23.

The gasket 24 is sandwiched and held by the negative-electrode flow-path layer 23 and the negative electrode 22 and/or negative-electrode energization plate 21 and avoids leakage of the slurry 10.

The positive-electrode chamber 30 is supplied with air. The positive-electrode chamber 30 is a space partitioned by the positive electrode 31 and the positive-electrode energization plate 32. The positive-electrode chamber 30 can have various shapes depending on the positive-electrode energization plate.

The positive electrode 31 is made of a conductive material and may have any shape.

The positive-electrode energization plate 32 is made of a conductive material that passes current between the positive electrode 31 and the positive-electrode energization plate 32.

Further, for a stack of a plurality of flow battery cells 100, the negative-electrode energization plates 21 and positive-electrode energization plates 32 of adjacent cells may be composed of a single component called a bipolar plate.

The separator 50 is provided between the negative-electrode flow-path layer 23 and the positive electrode 31 and prevents contact between solid active materials 11 in the slurry 10 and the positive electrode 31.

The seal portion 60 is provided between the negative-electrode flow-path layer 23 and the positive-electrode energization plate 32. The seal portion 60 may be in the form of a frame and disposed at the edges of the negative-electrode flow-path layer 23 and positive-electrode energization plate 32. In this way, the seal portion 60 produces a pressing force between the negative-electrode flow-path layer 23 and the positive-electrode energization plate 32, thereby preventing the slurry 10 from flowing into the positive-electrode chamber 30.

The slurry 10 contains an electrolytic solution 12 and an active material. The active material includes a substance dissolved in the electrolytic solution 12, and the solid active materials 11 having electron conductivity, and exceeding saturation solubility, thus not being dissolved in the electrolytic solution 12.

The active material is a negative-electrode active material. The negative-electrode active material is a metal species. Examples of the metal species include a zinc species, a cadmium species, a lithium species, a sodium species, a magnesium species, a lead species, a tin species, an aluminum species, and an iron species. The metal constituting the metal species may be a metal consisting of only metal, which is a major constituent, or may be an alloy of metal, which is a major constituent, and an accessory constituent. The metal species can be either a metal or an oxide. That the metal species is either a metal or an oxide depends on how much a discharge reaction or a charge reaction progresses.

When the flow battery cell 100 undergoes shipment, the metal species may be either a metal or an oxide. The oxidation state of the metal species may be uniform or non-uniform within the negative-electrode active material. For example, when the discharge reaction or the charge reaction progresses from the surface of the negative-electrode active material to the center of the same, the oxidation state of the metal species on the surface of the negative-electrode active material may be different from the oxidation state of the metal species at the center of the negative-electrode active material.

In this embodiment, the metal species is a zinc species, and the flow battery cell 100 is a zinc air battery. The metal constituting the zinc species may be a metal consisting of only zinc, which is a major constituent, or may be an alloy of zinc, which is a major constituent, and an accessory constituent.

The metal species in an oxidation state (e.g., ZnO), in which the metal species is an oxide, has an average particle diameter of several micrometers, and the metal species in a reduction state (e.g., Zn), in which the metal species is not an oxide, has an average particle diameter of about several tens of micrometers to 300 micrometers. The average particle diameter can be measured using a particle-size-distribution measuring device. The particle-size-distribution measuring device measures particle size distribution through, for instance, a laser diffraction/scattering method and calculates a median size, D50, as the average particle diameter from the measured particle size distribution.

The electrolytic solution 12 is selected in accordance with the metal species. When the metal species is a zinc species, the electrolytic solution 12 is an alkaline aqueous solution; for instance, the electrolytic solution 12 is a potassium-hydroxide aqueous solution or a sodium-hydroxide aqueous solution. When the metal species is a lithium species, the electrolytic solution 12 is a non-aqueous electrolytic solution. When the metal species is a magnesium species, the electrolytic solution 12 is a neutral aqueous solution; for instance, the electrolytic solution 12 is a sodium-chloride aqueous solution.

The slurry 10 contains the solid active materials 11. In the metal species, such as a zinc species, and the electrolytic solution 12 containing the solvent of a strong alkaline aqueous solution, such as a potassium-hydroxide aqueous solution, the metal species, such as zinc oxide or zinc, dissolves when its concentration is equal to or lower than saturation solubility, and the metal species, such as zinc oxide or zinc, remains as the solid active materials 11 without dissolving when its concentration is higher than the saturation solubility. Further, a solid active material particle can be identified by appearance. In the slurry 10 containing solid active material particles (without dissolving above saturation), the electrolytic solution is a suspended solution, and its color is white when the active material is zinc oxide. On the other hand, the electrolytic solution is transparent when it is a saturated solution, because the particles dissolve. As analysis, a method of measuring particle-size distribution is used; usable examples include a laser diffraction method and a dynamic light scattering method. In this embodiment, a suspended solution of a metal species, such as zinc oxide or zinc, is used for instance. Further, when compared with an active material dissolved in an electrolytic solution, the solid active materials 11 have a large electric capacity per unit volume, and a small amount of supply of the slurry 10 can supply the solid active materials 11 necessary for a reaction to the negative-electrode chamber 20 excessively; consequently, the feed of the slurry 10 can be paused, thereby reducing pump power consumption.

Further, the solid active materials 11 within the slurry 10 in this embodiment have a concentration of 5 to 50 wt % inclusive. In addition, 10 to 30 wt % is preferable. A concentration of 5 wt % or greater can form an electron-conducting path between the solid active materials 11 effectively. Further, a concentration of 50 wt % or smaller can prevent the viscosity of the slurry 10 from getting too high, thereby saving the pump power consumption.

The flow battery cell 100 according to the present disclosure is a discharge cell. During discharge, an oxidation reaction of the solid active materials (Formula (1) below) occurs in the negative electrode 22, and a reduction reaction of oxygen (Formula (2) below) occurs in the positive electrode 31.

Zn+4OH⁻→Zn(OH)₄²⁻+2e⁻→ZnO+H₂O⁺+2OH⁻2e⁻ (1)

½O₂+H₂O+2e⁻→2OH⁻ (2)

When the metal species is zinc, in Formula (1), metal zinc, which is the solid active materials, undergoes the oxidation reaction to be turned into zincate ions, and further into zinc oxide. In Formula (2), the reduction reaction of the oxygen provides hydroxide ions.

The solution-feed controlling unit 40 changes the rate of supply of the slurry 10. The solution-feed controlling unit 40 is a control device, such as a controller, that controls an output of the pump; in accordance with, but not limited to, the output of the pump, this unit controls the rate of supply of the slurry 10.

As described above, the flow battery cell 100 according to the present disclosure changes the rate of supply of the slurry 10 by the use of the solution-feed controlling unit 40, to temporarily increase the rate of feed of the slurry 10 containing the solid active materials 11 to shorten a time period for transferring the solid active materials 11 and reduce the feed rate to provide a time period for settling out the solid active materials 11. The solid active materials 11 settle out as a result of this feed rate reduction, thus bringing many of the solid active materials 11 into particle contact with each other to form electron-conducting paths. In addition, the materials come into contact with the negative electrode 22, thus increasing the area of reaction in the negative electrode. Doing so can reduce the pump power consumption without degrading battery performance.

Further, the flow battery cell 100 according to this embodiment is further provided with a slurry tank 70, as illustrated in FIG. 1. The slurry tank 70 may store the slurry 10 that is to be supplied to the negative-electrode chamber 20. The slurry 10 may be supplied from the slurry tank 70 to the negative-electrode chamber 20.

The slurry tank 70 may be provided with a stirrer 71.

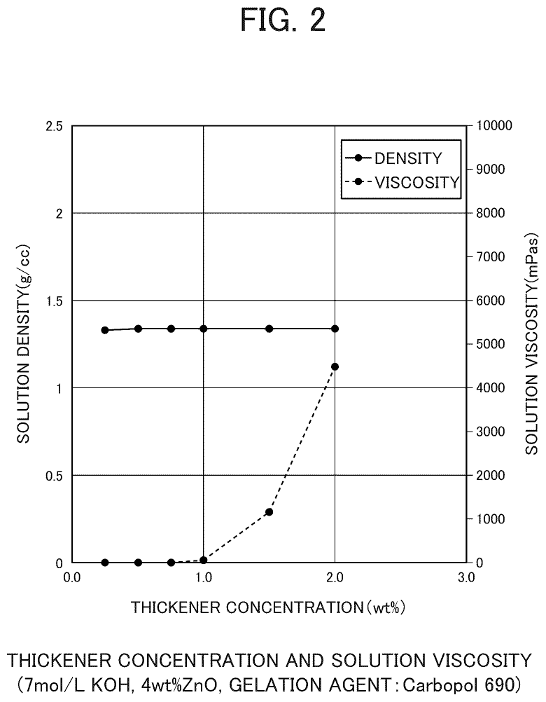

FIG. 2 is a graph showing thickener concentration and solution viscosity (electrolytic solution). As the electrolytic solution 12, 7 mol/L of KOH is used; as the active materials, 4 wt % of ZnO; and as a thickener, Carbopol690 (made by Lubrizol). The viscosity can be measured by the use of a viscometer. An example of the viscometer is Viscometer VT-06 made by RION Co., Ltd.; for measurement, any one of Rotors 1 to 3 is used.

The slurry 10 preferably contains a thickener. The electrolytic solution 12 and the solid active materials 11 are separated from each other in a very short time because the difference in specific gravity between the electrolytic solution 12 and solid active materials 11 is considerably large. As illustrated in FIG. 2, adding a thickener increases solution viscosity. That is, including a thickener reduces the rate of settlement of the solid active materials 11, thereby enabling the solid active materials 11 to be dispersed uniformly in the slurry 10 even after a lapse of time. Further, the slurry 10 may contain a gelation agent.

The thickener preferably has a concentration of 0.75 wt % or greater and less than 3 wt %, more desirably, a concentration of 1 wt % or greater and less than 2 wt %. At a concentration of less than 0.75 wt %, the rate of settlement of the solid active materials 11 is too high, requiring an increase in flow rate in order to transfer the solid active materials 11, thereby increasing the pump power consumption. Further, at a concentration of 3 wt % or greater, the viscosity is too high, producing a large pressure loss during the solution feed, thereby increasing the pump power consumption.

The electrolytic solution 12 preferably has a viscosity of 10 to 300 mPa·s inclusive. At a viscosity of less than 10 mPa·s, the rate of settlement of the solid active materials 11 is too high, requiring an increase in flow rate in order to transfer the solid active materials 11, thereby increasing the pump power consumption. Further, at a viscosity of greater than 300 mPa·s, the viscosity is too high, producing a large pressure loss during the slurry feed, thereby increasing the pump power consumption.

The slurry 10 preferably has a viscosity of 100 to 3000 mPa·s inclusive. At an excessively low viscosity, the rate of settlement of the solid active materials 11 is high, requiring a high frequency of increase in flow rate for transferring the solid active materials 11 that have settled out, thereby tending to increase the pump power consumption. At an excessively high viscosity on the other hand, a large pressure loss is produced in the solid active materials 11 during the slurry feed, thereby increasing the pump power consumption. In addition, since the solid active materials 11 remain dispersed without settling out, the negative electrode 22 and the solid active materials 11 do not come into contact with each other, or the particle of one solid active material 11 that has come into contact with the negative electrode 22 cannot come into continuous contact with the particle of another solid active material 11 (active material particles in electrical continuity with the negative electrode 22 are reduced, thus reducing the formation of electron-conducting paths), thereby failing to form electron-conducting paths from the solid active material 11 to the negative electrode 22, thus lowering the efficiency of use of the active materials. As such, the above-described range prevents an excessively high rate of settlement of the solid active materials 11, saves the pump power consumption, prevents a pressure loss during the solution feed and improves the efficiency of use of the active materials.

The foregoing has described the average particle diameter of the metal species; the solid active materials 11 in a reduction state, in which the solid active materials 11 are not oxides, preferably have an average particle diameter of 30 to 300 μm inclusive. In a diameter of less than 30 μm, the particles of the solid active materials 11 are less likely to come into contact together, making it difficult to form electron-conducting paths. In a diameter of greater than 300 μm, the rate of settlement of the solid active materials 11 is high, requiring an increase in flow rate in order to transfer the particles of the solid active materials 11 that have settled out, thereby increasing the pump power consumption.

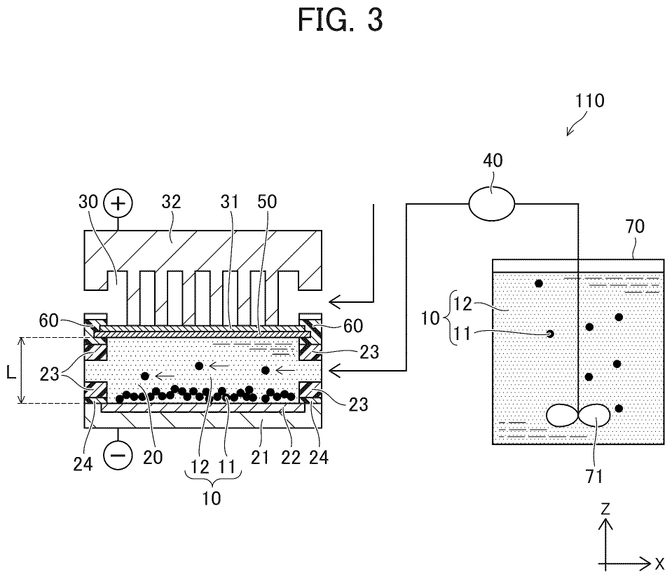

FIG. 3 is a schematic cross-sectional view of a modification of the flow battery cell 100 illustrated in FIG. 1. As illustrated in the flow battery cell, 110, in FIG. 3, the negative electrode 22 is disposed in a downward direction of gravity with respect to the positive-electrode chamber 30. Doing so settles out the solid active materials 11 on the negative electrode 22, thereby enabling electron-conducting paths to be formed effectively from the solid active materials 11 to the negative electrode 22. This can improve electric capacity further.

The solution-feed controlling unit 40 preferably reduces the rate of supply of the slurry 10 or stops supplying the slurry 10 during electric-power generation. Doing so can save the pump power consumption. In reducing the rate of supply of the slurry 10, the slurry flow is maintained, so that the solid active materials 11 within the slurry 10 can be prevented from sticking to and accumulating in the negative-electrode chamber. In stopping the supply of the slurry 10, zero pump power consumption can be achieved.

During the electric-power generation, the solution-feed controlling unit 40 preferably performs control in such a manner that the time for reducing the rate of supply of the slurry 10 is longer than the time for supplying the slurry 10; more desirably, the solution-feed controlling unit 40 preforms control in such a manner that the time for stopping supplying the slurry 10 is longer than the time for supplying the slurry 10. Doing so promotes accumulation of the solid active materials 11, thereby enabling electron-conducting paths to be formed effectively from the solid active materials 11 to the negative electrode. In addition, the rate of supply of the slurry 10 is reduced, or the supply is stopped, thus saving the pump power consumption.

It is preferable that the solution-feed controlling unit 40 periodically change the rate of supply during the electric-power generation. Doing so can feed the slurry 10 efficiently to the negative-electrode chamber 20, thereby enabling efficient electric-power generation. Further, the solution-feed controlling unit 40 may periodically switch between supply or no supply (supply/stop) during the electric-power generation. The term “periodically” means that change in the rate of supply, or switch between supply or no supply is made a plurality of times at any time intervals.

The stirrer 71 preferably operates periodically.

Furthermore, the stirrer 71 preferably operates in synchronization with the solution-feed controlling unit 40. For instance, the stirrer 71 operates while the solution-feed controlling unit 40 is supplying the slurry 10. On the other hand, the stirrer 71 stops while the solution-feed controlling unit 40 is stopping the supply of the slurry 10. Further, the stir in the stirrer 71 does not have to coincide with the solution feed; the stirrer 71 may operate after a lapse of any time from the switch of the solution feed. Further, when the solution-feed controlling unit 40 periodically switches between supply or no supply (supply/stop), the stirrer 71 periodically switches between stir and no stir accordingly.

The rate of settlement of the solid active materials 11 is in accordance with Stokes' law as follows.

vₛ=Dₚ²(ρₚ−ρ−_{f})g/18η
vₛ: particle terminal speed
Dₚ: particle diameter
ρₚ: particle density
ρ_{f}: fluid density
g: gravity acceleration
η: fluid viscosity

It is preferable that T>L×35 be satisfied, where L(cm) denotes the distance from the separator 50 to the negative electrode 22, and T(s) denotes the period of change in the rate of supply. The rate of settlement of the solid active materials 11 is determined in accordance with particle diameter, density, and viscosity from Stokes' law, and the solid active materials 11 settle out to form, together with the negative electrode 22, electron-conducting paths; thus, if the period of change in the rate of supply is short with respect to the rate of settlement and the distance of settlement, which is herein the distance from the separator 50 to the negative electrode 22, sufficient electron-conducting paths are difficult to form, degrading the battery performance. In Stokes' law, let the particle diameter be set at 300 μm, let the fluid viscosity be set at 10 mPa·s, let the fluid density be set at 1.34 g/cm³, and let particle density be set at 7.14 g/cm³; accordingly, the calculated rate of settlement vₛ is 2.842×10\hat{ }(−2) m/s. It is noted that the period of change in the rate of supply is a period in which the rate of supply of the slurry 10 is “fast/slow” or a period of the “supply/no supply; a slight difference in the rate of supply is sufficient.

For instance, for a distance L of 1 cm from the separator 50 to the negative electrode 22, average discharge voltage is low when the period, T, of change in the rate of supply is set at 30 sec, whereas the average discharge voltage is high when the period T is set at 60 sec. Further, for a distance L of 0.5 cm, the average discharge voltage is low when the period T is set at 10 sec, whereas the average discharge voltage is high when the period T is set at 20 sec.

Further, when the solid active materials 11 are zinc, S×ρ×(X/100)/65.4>I×T/(96500×2) is preferably satisfied, where S (cm³) denotes the volume of the negative-electrode chamber 20, ρ(g/cm³) denotes the density of the slurry 10, I(A) denotes discharge current, and X(wt %) denotes the weight ratio of the zinc within the slurry 10.

That is, this means that the amount of zinc consumed during electric discharge by the period T is smaller than the amount of all zinc being present in the negative-electrode chamber 20. If the number of zinc particles being present in the negative-electrode chamber 20 is less than the number of zinc particles consumed during electric discharge at current I by the period T, electric discharge tends to be impossible because there is no zinc at all that can undergo electric discharge; for this reason, the foregoing expression is preferably satisfied.

Further, in (S×ρ×(X/100)/65.4)×M>I×T/(96500×2), it is more desirable that 1/10<M<½ be satisfied, and it is furthermore desirable that ⅕<M<⅓ be satisfied. When M is smaller than 1/10, the period T is shorten, increasing the pump power consumption. When M is equal to or greater than ½, zinc oxide deposited in the slurry 10 being present in the negative-electrode chamber 20 constitutes resistance, thus possibly lowering discharge voltage. The foregoing range can avoid degradation in the battery performance while saving the pump power consumption.

It is preferable that 0.4<α<0.97 be satisfied, where α denotes the ratio of flow time during which the rate of slurry supply is reduced, or the ratio of time during which the flow (supply) is stopped to the period of change in the rate of slurry supply. Doing so enables the solid active materials 11 to form sufficient electron-conducting paths, thereby improving the efficiency of use of the active materials.

As described above, the flow battery cells 100 and 110 according to the present disclosure can improve the electric capacity and save the pump energy consumption.

While the embodiment and example of the present disclosure have been described in detail above, those skilled in the art will readily understand that many modifications are possible that do not substantially depart from the new matters and effects of the present disclosure. Accordingly, all such modifications shall be all included in the scope of the present disclosure.

For example, a term that is described at least once in the Specification or drawings together with a different term that is broader or synonymous can be replaced with the different term anywhere in the Specification or drawings. In addition, the configuration and operation of the flow battery cells are not limited to those described in the embodiment and example of the present disclosure; that is, various modifications are possible.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A flow battery cell comprising:
a slurry containing solid active materials and an electrolytic solution;
a negative-electrode chamber for supplying the slurry;
a positive-electrode chamber for supplying air; and
a solution-feed controlling unit configured to change a rate of supply of the slurry.

2. The flow battery cell according to claim 1, wherein the slurry contains a thickener.

3. The flow battery cell according to claim 1, wherein the electrolytic solution has a viscosity of 10 to 300 mPa·s.

4. The flow battery cell according to claim 1, wherein the slurry has a viscosity of 100 to 3000 mPa·s.

5. The flow battery cell according to claim 1, wherein the solid active materials have an average particle diameter of 30 to 300 μm.

6. The flow battery cell according to claim 1, further comprising a negative electrode,
wherein the negative electrode is disposed in a downward direction of gravity with respect to the positive-electrode chamber.

7. The flow battery cell according to claim 1, wherein the solution-feed controlling unit reduces the rate of supply of the slurry or stops supplying the slurry during electric-power generation.

8. The flow battery cell according to claim 7, wherein the solution-feed controlling unit stops supplying the slurry during the electric-power generation.

9. The flow battery cell according to claim 7, wherein the solution-feed controlling unit performs control in such a manner that a time for reducing the rate of supply of the slurry is longer during the electric-power generation.

10. The flow battery cell according to claim 8, wherein the solution-feed controlling unit performs control in such a manner that a time for stopping supplying the slurry is longer than a time for supplying the slurry during the electric-power generation.

11. The flow battery cell according to claim 1, wherein the solution-feed controlling unit periodically changes the rate of supply during electric-power generation.

12. The flow battery cell according to claim 1, wherein the solid active materials within the slurry have a concentration of 5 to 50 wt %.

13. The flow battery cell according to claim 1, further comprising a slurry tank,
wherein the slurry tank is provided with a stirrer.

14. The flow battery cell according to claim 13, wherein the stirrer operates periodically.

15. The flow battery cell according to claim 13, wherein the stirrer operates in synchronization with the solution-feed controlling unit.

16. The flow battery cell according to claim 11, further comprising:
a negative electrode; and
a separator separating the negative-electrode chamber and the positive-electrode chamber from each other,
wherein T>L×35 is satisfied, where L(cm) denotes a distance from the separator to the negative electrode, and T(s) denotes a period of change in the rate of supply.

17. The flow battery cell according to claim 11, wherein
the solid active materials contain zinc, and
S×ρ×(X/100)/65.4>I×T/(96500×2) is satisfied, where S (cm³) denotes a volume of the negative-electrode chamber, ρ(g/cm³) denotes a density of the slurry, I(A) denotes a discharge current, and X wt %) denotes a weight ratio of the zinc within the slurry.

18. The flow battery cell according to claim 11, wherein 0.4<α<0.97 is satisfied, where α denotes a ratio of a flow time during which the rate of supply of the slurry is reduced, or a ratio of a time during which a flow is stopped.
